(19) United States
(12) Patent Application Publication
(10) Pub. No.: US 2011/0102401 A1
(43) Pub. Date: May 5, 2011

(54) LIQUID CRYSTAL DISPLAY DEVICE AND DRIVING METHOD THEREOF

(75) Inventor: SHA FENG, Shenzhen (CN)

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/844,805

(22) Filed: Jul. 27, 2010

(30) Foreign Application Priority Data
Oct. 30, 2009 (CN) 200910309171.1

(51) Int. Cl. G09G 3/36; G06F 3/038

(52) U.S. Cl. 345/211; 345/98

(57) ABSTRACT

A liquid crystal display (LCD) device includes a common voltage generating circuit, a common voltage compensating circuit, and a liquid crystal panel. The liquid crystal panel includes gate lines parallel to each other, data lines isolated from and intersecting with the gate lines, common voltage lines parallel to the gate lines, and a coupling line isolated from and intersecting with the data lines. A method for driving the LCD device includes the common voltage compensating circuit generating and providing an original common voltage and the coupling line generating a feedback signal when data signals on the plurality of data lines change. The common voltage compensating circuit generates a compensating signal according to the feedback signal and compensates the original common voltage, and outputs a compensated common voltage to the common voltage lines.

### BACKGROUND

1. Technical Field

The present disclosure generally relates to display devices, and particularly to a liquid crystal display (LCD) device and a driving method for the LCD device.

2. Description of Related Art

Commonly used LCD devices have the advantages of portability, low power consumption, and low radiation, and are widely used in various electronic devices such as notebooks, personal digital assistants (PDAs), video cameras, televisions, and others. Usually, an LCD device includes a liquid crystal panel to display images. The liquid crystal panel includes a plurality of common voltage lines, a plurality of gate lines, a plurality of data lines, and a plurality of pixel units defined by the gate lines and the data lines.

Referring to FIG. 1, a schematic circuit diagram of a pixel unit of a typical LCD device is shown. The pixel unit 100 includes a thin film transistor (TFT) 101 and a pixel electrode 102. A gate electrode of the TFT 101 is connected to a corresponding gate line 103, a source electrode of the TFT 101 is connected to a corresponding data line 104, and a drain electrode of the TFT 101 is connected to the pixel electrode 102. The pixel electrode 102, a common voltage line 105 corresponding to the pixel unit 100, and an insulating layer (not labeled) therebetween cooperatively form a storage capacitor 106. The pixel electrode 102, a common electrode 107, and a liquid crystal layer (not labeled) therebetween cooperatively form a liquid crystal capacitor 108.

When the LCD device displays a frame of image, a common voltage is provided to the common electrode 107 and the common voltage line 105. When a gate signal is provided to the gate line 103 to turn on the TFT 101, a data signal is provided to the pixel electrode 102 via the data line 104 and the activated TFT 101, and the liquid crystal capacitor 108 and the storage capacitor 106 charge. After the liquid crystal capacitor 108 and the storage capacitor 106 are charged, a gray voltage is held between the common electrode 107 and the pixel electrode 102 until another gate signal is provided in a successive frame. In an electric field generated by the gray voltage, liquid crystal molecules of the liquid crystal layer twist to control a transmissive amount of light beams to display the image.

However, the common voltage line 105 and the gate line 103 are usually formed on the same layer during manufacture of the LCD device, and the insulating layer is formed between the layer of the common voltage line 105 and a layer of the data line 104. A parasitic capacitor is formed by the common voltage line 105, the data line 104, and the insulating layer therebetween. When the data signal changes on the data line 104, the common voltage on the common voltage line 105 can be disturbed due to the parasitic capacitor. Therefore, crosstalk is generated, distorting the image displayed on the LCD device.

What is needed, therefore, is an LCD device and a driving method thereof which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic circuit diagram of a pixel unit of a commonly used LCD device.

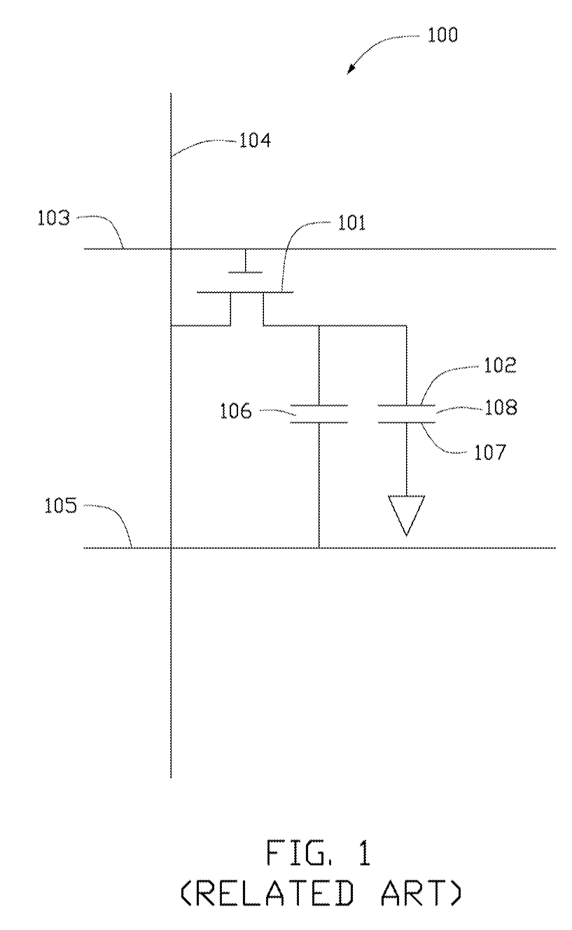

FIG. 2 is a schematic circuit diagram of a first embodiment of an LCD device, the LCD device including a common voltage compensating circuit.

FIG. 3 is a schematic circuit diagram of the common voltage compensating circuit of FIG. 2.

FIG. 4 is a flow chart of a method for driving the LCD device of FIG. 2.

FIG. 5 is a schematic circuit diagram of a second embodiment of an LCD device, the LCD device including a common voltage compensating circuit.

FIG. 6 is a schematic circuit diagram of the common voltage compensating circuit of FIG. 5.

FIG. 7 is a schematic circuit diagram of a third embodiment of an LCD device, the LCD device including a second common voltage compensating circuit.

FIG. 8 is a schematic circuit diagram of the second common voltage compensating circuit of FIG. 7.

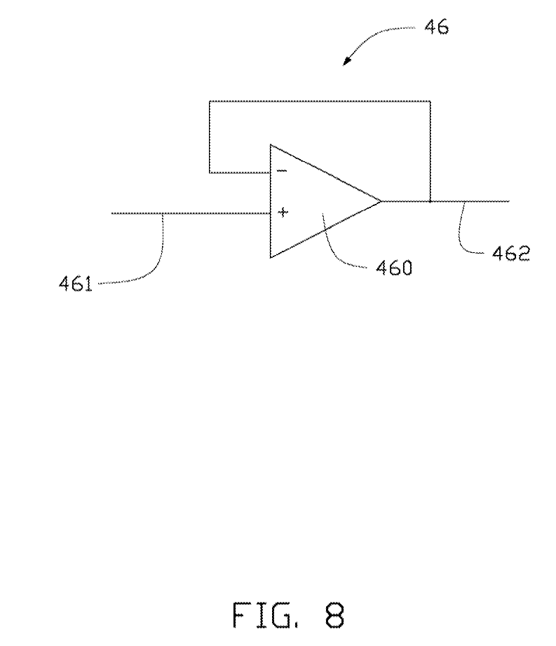

### DETAILED DESCRIPTION

Reference will now be made to the drawings to describe various embodiments in detail.

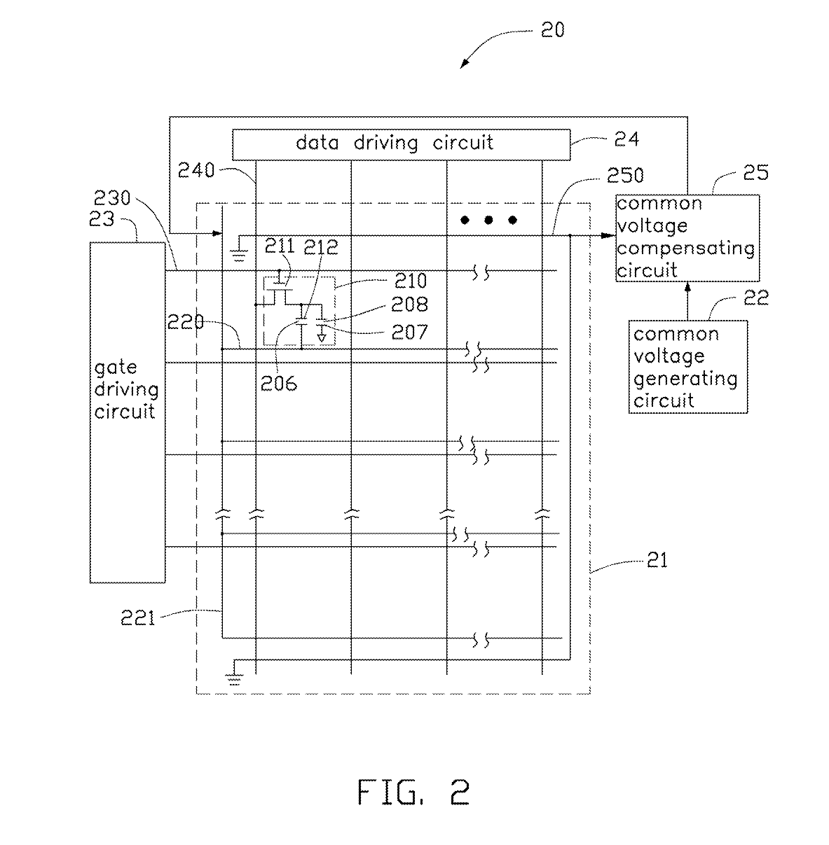

Referring to FIG. 2, a schematic circuit diagram of a first embodiment of an LCD device 20 is shown. The LCD device 20 includes a liquid crystal panel 21, a common voltage generating circuit 22, a gate driving circuit 23, a data driving circuit 24, and a common voltage compensating circuit 25.

The liquid crystal panel 21 includes a plurality of gate lines 230 parallel to each other, a plurality of data lines 240 isolated from and intersecting with the gate lines 230, a plurality of pixel units 210 defined by the gate lines 230 and the data lines 240, a plurality of common voltage lines 220 alternately disposed with and parallel to the gate lines 230, a common voltage supply line 221, and a coupling line 250.

Each pixel unit 210 includes a TFT 211 and a pixel electrode 212. A gate electrode of the TFT 211 is connected to a corresponding gate line 230, a source electrode of the TFT 211 is connected to a corresponding data line 240, and a drain electrode of the TFT 211 is connected to the pixel electrode 212. The pixel electrode 212, a corresponding common voltage line 220, and an insulating layer (not labeled) therebetween cooperatively form a storage capacitor 206. The pixel electrode 212, a common electrode 207, and a liquid crystal layer (not labeled) therebetween cooperatively form a liquid crystal capacitor 208.

The gate lines 230 are connected to the gate driving circuit 23 to receive gate signals output therefrom. The data lines 240 are connected to the data driving circuit 24 to receive data signals output therefrom. The common voltage supply line 221 is connected to the common voltage generating circuit 22 via the common voltage compensating circuit 25. The common voltage supply line 221 receives a common voltage output from the common voltage generating circuit 22 and compensated by the common voltage compensating circuit 25, and provides the common voltage to the common voltage lines 220. The common voltage supply line 221 may be disposed on a side of the liquid crystal panel 21 and parallel to the data lines 240. The coupling line 250 is disposed at a side of the data driving circuit 24 adjacent to the gate lines 230, and is isolated from and intersects with the data lines 240. One terminal of the coupling line 250 is connected to the common voltage compensating circuit 25, and the other terminal of the coupling line 250 is grounded. The other terminal of the coupling line 250 also may be chosen to be floated or connected to a constant voltage source. Coupling capacitors (not shown) are formed between the coupling line 250 and the data lines 240. When the data signals output from the data driving circuit 24 change, the coupling line 250 provides a feedback signal to the common voltage compensating circuit 25 by utilizing the coupling capacitors.

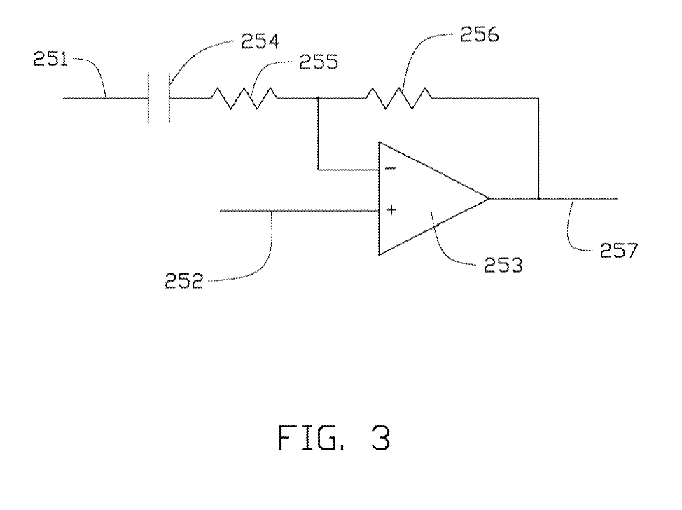

Referring also to FIG. 3, a schematic circuit diagram of the common voltage compensating circuit 25 is shown. The common voltage compensating circuit 25 includes a first input terminal 251, a second input terminal 252, an operational amplifier 253, a capacitor 254, a first resistor 255, a second resistor 256, and an output terminal 257. An inverting terminal of the operational amplifier 253 is connected to the first input terminal 251 via the first resistor 255 and the capacitor 254 in that order, and is also connected to the output terminal 257 via the second resistor 256. A non-inverting terminal of the operational amplifier 253 is connected to the second input terminal 252. An output of the operational amplifier 253 is connected to the output terminal 257. The first input terminal 251 is connected to the coupling line 250 to receive the feedback signal generated by the coupling line 250. The second input terminal 252 is connected to the common voltage generating circuit 22 to receive an original common voltage generated by the common voltage generating circuit 22. The output terminal 257 outputs the common voltage compensated by the common voltage compensating circuit 25 to the common voltage supply line 221.

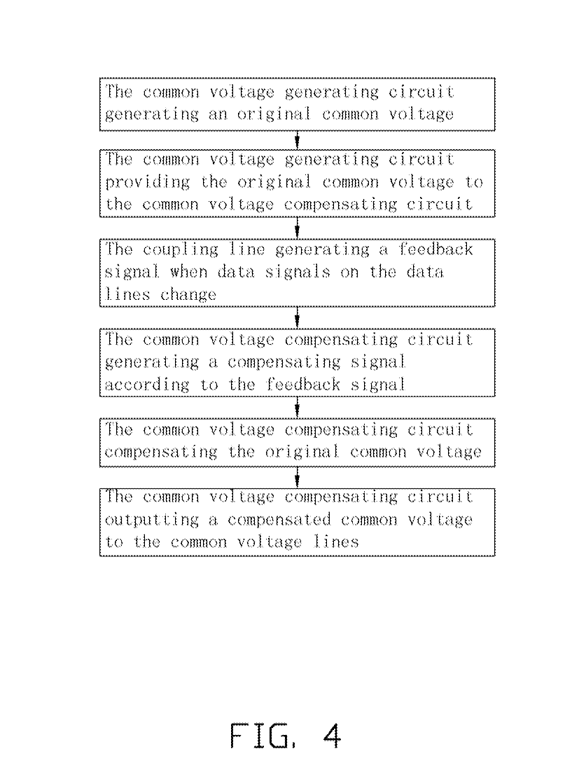

Referring to FIG. 4, a method for driving the LCD 20 is shown. The method includes: the common voltage generating circuit 22 generating an original common voltage; the common voltage generating circuit 22 providing the original common voltage to the common voltage compensating circuit 25; the coupling line 250 generating a feedback signal when data signals on the data lines 240 change; the common voltage compensating circuit 25 generating a compensating signal according to the feedback signal; the common voltage compensating circuit 25 compensating the original common voltage; and the common voltage compensating circuit 25 outputting a compensated common voltage to the common voltage lines 220.

That is, when the LCD device 20 displays an image, the gate driving circuit 23 generates a plurality of gate signals, and successively provides the gate signals to the gate lines 230. When a gate line 230 receives a corresponding gate signal, a row of TFTs 211 connected to the gate line 230 is turned on. The data driving circuit 24 provides a data signal to a corresponding pixel unit 212 via a corresponding data line 240 and the corresponding activated TFT 211. The common voltage generating circuit 22 generates the original common voltage and outputs the original common voltage to the common voltage compensating circuit 25. The coupling line 250 reflects information of the data signal via the coupling capacitors, and generates and outputs the feedback signal to the common voltage compensating circuit 25. The feedback signal is provided to the inverting terminal of the operational amplifier 253 via the capacitor 254 and the first resistor 255, and is modulated to a compensating signal by the first resistor 255, the second resistor 256, and the operational amplifier 253. The compensating signal is loaded on the original common voltage to compensate the original common voltage.

Then the output terminal 257 of the common voltage compensating circuit 25 outputs the compensated common voltage to the common voltage lines 220 via the common voltage supply line 221.

Even though the common voltage on the common voltage lines 220 is affected by parasitic capacitors between the common voltage lines 220 and the data lines 240, the common voltage is compensated prior thereto by the common voltage compensating circuit 25. Therefore, the affect of the parasitic capacitors between the common voltage lines 220 and the data lines 240 can be counteracted by the compensating signal according to the feedback signal from the coupling capacitors. Thus, the crosstalk can be eliminated, and the display of the LCD device 20 is unaffected.

In an alternative embodiment, two or more coupling lines 250 isolated from and intersecting with the data lines 240 can be disposed on the liquid crystal panel 21. One terminal of the coupling lines 250 is connected to the first input terminal 251 of the common voltage compensating circuit 25, and the other terminals of the coupling lines 250 are grounded. The other terminals of the coupling lines 250 also may be chosen to be floated or connected to a constant voltage source.

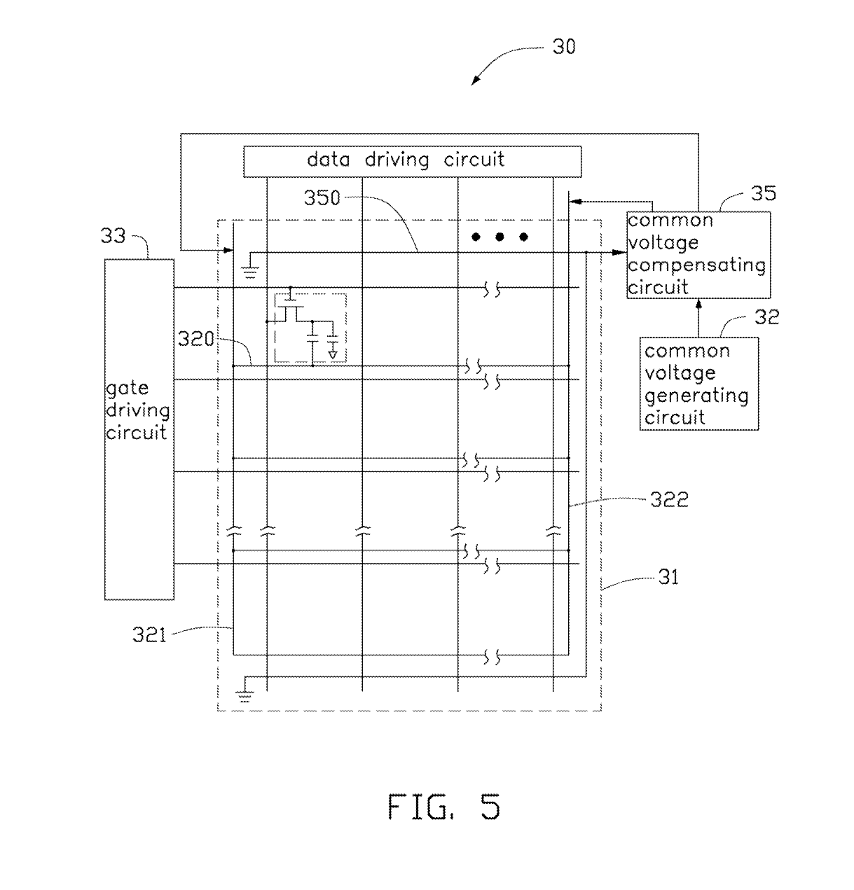

Referring to FIG. 5, a schematic circuit diagram of a second embodiment of an LCD device 30 is shown. The LCD device 30 is similar to the LCD device 20, but includes a first common voltage supply line 321 and a second common voltage supply line 322. The first common voltage supply line 321 is disposed on a side of the liquid crystal panel 31 adjacent to the gate driving circuit 33. The second common voltage supply line 322 is disposed on the other side of the liquid crystal panel 31 far away from the gate driving circuit 33. Two terminals of a plurality of common voltage lines 320 are respectively connected to the first and the second common voltage supply lines 321, 322.

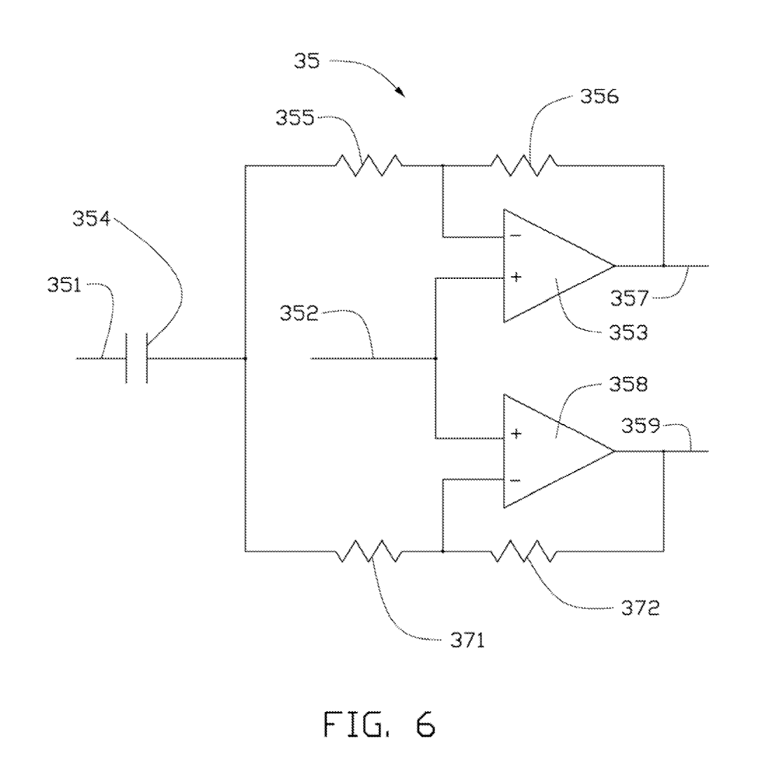

Referring also to FIG. 6, a schematic circuit diagram of a common voltage compensating circuit 35 of the LCD device 30 is shown. The common voltage compensating circuit 35 includes a first input terminal 351, a second input terminal 352, a first operational amplifier 353, a second operational amplifier 358, a capacitor 354, a first resistor 355, a second resistor 356, a third resistor 371, a fourth resistor 372, a first output terminal 357, and a second output terminal 359. An inverting terminal of the first operational amplifier 353 is connected to the first input terminal 351 via the first resistor 355 and the capacitor 354 in that order, and is also connected to the first output terminal 357 via the second resistor 356. An output of the first operational amplifier 353 is connected to the first output terminal 357. An inverting terminal of the second operational amplifier 358 is connected to the first input terminal 351 via the third resistor 371 and the capacitor 354 in that order, and is also connected to the second output terminal 359 via the fourth resistor 372. An output of the second operational amplifier 358 is connected to the second output terminal 359. Non-inverting terminals of the first and the second operational amplifiers 353, 358 are connected to the second input terminal 352. The first input terminal 351 is connected to a coupling line 350 to receive a feedback signal generated by the coupling line 350. The second input terminal 352 is connected to a common voltage generating circuit 32 to receive an original common voltage generated by the common voltage generating circuit 32. The first output terminal 357 outputs a first common voltage compensated by the common voltage compensating circuit 35 to the first common voltage supply line 321, and the second output terminal 359 outputs a second common voltage compensated by the common voltage compensating circuit 35 to the second common voltage supply line 322.

Due to the difference in locations of the first and the second common voltage supply lines 321, 322 on the liquid crystal panel 31, common voltages there may also differ. Thus, the resistances of the first, the second, the third, and the fourth resistors 355, 356, 371, 372 can be regulated and preset according to an actual situation, and the common voltages on the first and the second common voltage supply line 321, 322 can be respectively compensated by the common voltage compensating circuit 35.

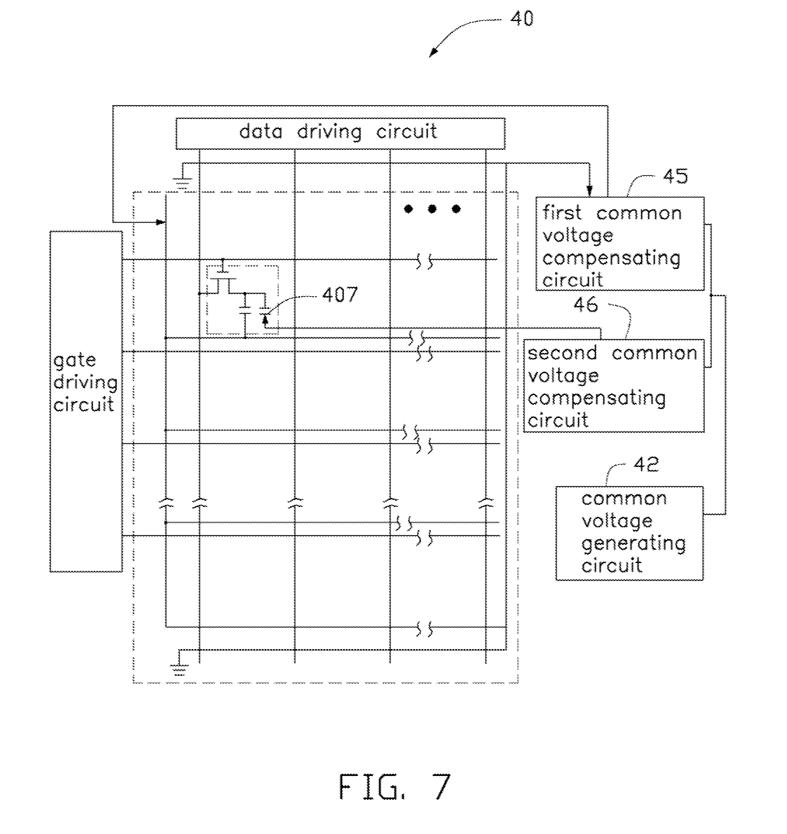

FIG. 7 is a schematic circuit diagram of a third embodiment of an LCD device 40, differing from LCD device 20 and LCD device 30 only in the inclusion of a first common voltage compensating circuit 45 and a second common voltage compensating circuit 46. The first common voltage compensating circuit 45 may be the same as the common voltage compensating circuit 25 of the LCD device 20 or the common voltage compensating circuit 35 of the LCD device 30.

Referring also to FIG. 7, a schematic circuit diagram of the second common voltage compensating circuit 46 is shown. The second common voltage compensating circuit 46 may be a voltage follower, and includes an input terminal 461, an output terminal 462, and an operational amplifier 460. An output of the operational amplifier 460 is connected to the output terminal 462, and is also connected to an inverting terminal of the operational amplifier 460. A non-inverting terminal of the operational amplifiers 460 is connected to the input terminal 461 to receive an original common voltage output from a common voltage generator 42. The second common voltage compensating circuit 46 outputs a steady common voltage to a common electrode 407.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A liquid crystal display (LCD) device, comprising:
a common voltage generating circuit to generate an original common voltage;
a first common voltage compensating circuit to compensate the original common voltage; and
a liquid crystal panel, comprising:
a plurality of gate lines parallel to each other;
a plurality of data lines isolated from and intersecting with the plurality of gate lines;
a plurality of common voltage lines parallel to the plurality of gate lines; and
a coupling line isolated from and intersecting with the plurality of data lines to provide a feedback signal to the first common voltage compensating circuit;
wherein the first common voltage compensating circuit receives the feedback signal, generates a compensation signal according to the feedback signal to compensate an original common voltage, and outputs a first compensated common voltage to the plurality of common voltage lines.

2. The LCD device of claim 1, wherein coupling capacitors are formed between the coupling line and the data lines, and the coupling line provides the feedback signal to the first common voltage compensating circuit when data signals on the plurality of data lines change, the feedback signal reflecting information of the data signals on the plurality of data lines via the coupling capacitors.

3. The LCD device of claim 2, wherein the coupling capacitors between the coupling line and the data lines generate the feedback signal to the first common voltage compensating circuit, the first common voltage compensating circuit in turn adds the compensation signal to the original common voltage, substantially counteracting an effect of parasitic capacitors between the plurality of common voltage lines and the plurality of data lines on the common voltage.

4. The LCD device of claim 3, wherein the first common voltage compensating circuit comprises a first input terminal, a second input terminal, an operational amplifier, a first resistor, a second resistor, and an output terminal, wherein an inverting terminal of the operational amplifier is connected to the first input terminal via the first resistor and also to the output terminal via the second resistor, a non-inverting terminal of the operational amplifier is connected to the second input terminal, an output of the operational amplifier is connected to the output terminal, the first input terminal is connected to the coupling line to receive the feedback signal, the second input terminal is connected to the common voltage generating circuit to receive the original common voltage, and the output terminal outputs the first compensated common voltage to the plurality of common voltage lines.

5. The LCD device of claim 4, wherein the first common voltage compensating circuit further comprises a capacitor connected between the first input terminal and the first resistor.

6. The LCD device of claim 4, wherein the liquid crystal panel further comprises a common voltage supply line connected to the plurality of common voltage lines, and the first common voltage compensating circuit provides the first compensated common voltage to the plurality of common voltage lines via the common voltage supply line.

7. The LCD device of claim 3, wherein the liquid crystal panel further comprises a first common voltage supply line and a second common voltage supply line respectively connected to two terminals of the plurality of common voltage lines.

8. The LCD device of claim 7, wherein the first common voltage compensating circuit comprises a first input terminal, a second input terminal, a first operational amplifier, a second operational amplifier, a first resistor, a second resistor, a third resistor, a fourth resistor, a first output terminal, and a second output terminal, wherein an inverting terminal of the first operational amplifier is connected to the first input terminal via the first resistor and also to the first output terminal via the second resistor, an output of the first operational amplifier is connected to the first output terminal, an inverting terminal of the second operational amplifier is connected to the first input terminal via the third resistor and also to the second output terminal via the fourth resistor, an output of the second operational amplifier is connected to the second output terminal, non-inverting terminals of the first and the second operational amplifiers are connected to the second input terminal, the first input terminal is connected to the coupling line to receive the feedback signal, the second input terminal is connected to the common voltage generating circuit to receive the original common voltage, the first output terminal outputs the first compensated common voltage to the first common voltage supply line, and the second output terminal outputs a second compensated common voltage to the second common voltage supply line.

9. The LCD device of claim 8, wherein the first common voltage compensating circuit further comprises a capacitor connected between the first input terminal and the first resistor and also between the first input terminal and the third resistor.

10. The LCD device of claim 3, wherein the liquid crystal panel further comprises a plurality of pixel units defined by the plurality of the gate lines and the plurality of the date lines, each pixel unit comprising a pixel electrode, and the pixel electrode, a common electrode, and a liquid crystal layer therebetween forming a liquid crystal capacitor.

11. The LCD device of claim 10, further comprising a second common voltage compensating circuit, wherein the second common voltage compensating circuit comprises an input terminal and an output terminal, the input terminal receiving the original common voltage output from the common voltage generating circuit, and the output terminal outputting a steady common voltage to the common electrode.

12. The LCD device of claim 11, wherein the second common voltage compensating circuit is a voltage follower.

13. The LCD device of claim 3, wherein one terminal of the coupling line is connected to the first common voltage compensating circuit, and the other terminal of the coupling line is grounded or floated.

14. The LCD device of claim 3, wherein one terminal of the coupling line is connected to the first common voltage compensating circuit, and the other terminal of the coupling line is connected to a constant voltage source.

15. The LCD device of claim 3, wherein the number of coupling line is more than one.

16. A method for driving a liquid crystal display (LCD) device, the LCD device comprising a common voltage generating circuit, a common voltage compensating circuit, and a liquid crystal panel, the liquid crystal panel comprising a plurality of gate lines parallel to each other, a plurality of data lines isolated from and intersecting with the plurality of gate lines, a plurality of common voltage lines parallel to the plurality of gate lines, and a coupling line isolated from and intersecting with the plurality of data lines, the method comprising:
the common voltage generating circuit generating an original common voltage;
the common voltage generating circuit providing the original common voltage to the common voltage compensating circuit;
the coupling line generating a feedback signal when data signals on the plurality of data lines change;
the common voltage compensating circuit generating a compensating signal according to the feedback signal;
the common voltage compensating circuit compensating the original common voltage; and
the common voltage compensating circuit outputting a compensated common voltage to the plurality of common voltage lines.

17. The method of claim 16, wherein coupling capacitors are formed between the coupling line and the data lines, and the coupling line provides the feedback signal to the common voltage compensating circuit when data signals on the plurality of data lines change, the feedback signal reflecting information of the data signals on the plurality of data lines via the coupling capacitors.

18. The method of claim 17, wherein the coupling capacitors between the coupling line and the data lines generate the feedback signal to the common voltage compensating circuit, the common voltage compensating circuit in turn adds the compensation signal to the original common voltage, substantially counteracting the effect of parasitic capacitors between the plurality of common voltage lines and the plurality of data lines on the common voltage.

19. The method of claim 18, wherein one terminal of the coupling line is connected to the common voltage compensating circuit, and the other terminal of the coupling line is grounded or floated.

20. The method of claim 18, wherein the LCD device further comprises another common voltage compensating circuit, the liquid crystal panel further comprises a common electrode, and the method further comprises:
the common voltage generating circuit providing the original common voltage to the another common voltage compensating circuit; and
the another common voltage compensating circuit outputting a steady common voltage to the common electrode.
